(19) United States
(12) Patent Application Publication
(10) Pub. No.: US 2025/0392971 A1
(43) Pub. Date: Dec. 25, 2025

(54) HANDLING OF IDLE-INACTIVE UE'S DURING HANDOVER WITH MOBILE IAB

(71) Applicant: Telefonaktiebolaget LM Ericsson (publ), Stockholm (SE)

(72) Inventors: Antonino ORSINO, Kirkkonummi (FI); Ritesh SHREEVASTAV, Upplands Väsby (SE)

(21) Appl. No.: 18/879,505

(22) PCT Filed: Aug. 22, 2023
(86) PCT No.: PCT/SE2023/050848

§ 371 Date: Dec. 27, 2024

Related U.S. Application Data
(60) Provisional application No. 63/410,492, filed on Sep. 27, 2022.

(51) Int. Cl. H04W 36/08; H04W 48/20; H04W 76/27

(52) U.S. Cl. CPC H04W 36/08; H04W 48/20; H04W 76/27

(57) ABSTRACT

A method at a user equipment, UE that is served by a mobile integrated access backhaul, IAB, and which radio resource control, RRC, status is RRC_IDLE or RRC_INACTIVE includes receiving from the mobile IAB a first indication that the UEs in RRC_CONNECTED connected to the same mobile IAB are initiating or have initiated a handover procedure to a target cell. The method includes receiving a second indication about to which target cell the UEs in RRC_CONNECTED have been handed off.

### TECHNICAL FIELD

The present disclosure relates generally to communications, and more particularly to communication methods and related devices and nodes supporting wireless communications.

### BACKGROUND

An integrated access and backhaul (IAB) overview provides that fifth generation (5G) networks are being designed and deployed considering a dense deployment of small cells in order to simultaneously serve more User Equipment (UEs) with higher throughput and lower delay. However, building from scratch a completely new infrastructure is costly and takes time. Deploying a wireless backhaul is then envisioned to be an economically and technically viable approach to enable flexible and dense network.

This solution was standardized in 3GPP release 16, under the term Integrated Access and Backhaul (IAB), to support wireless relaying in NG-RAN and has continued in subsequent releases.

IAB is based on the CU-DU split that was standardized in previous releases. The centralized unit (CU) is in charge of the radio resource control (RRC) and the packet data convergence (PCDP) protocol, whereas the distributed unit (DU) is in charge of the radio link control (RLC) and multiple access control (MAC). The F1 interface connects the CU and the DU. The CU-DU split facilitates separate physical CU and DU, while also allowing a single CU to be connected to multiple DUs. Brief reference is now made to FIG. 1, which is a schematic block diagram illustrating a basic architecture of IAN. In FIG. 1, the master network node 120 and secondary network node 130 communicates with each other, with UEs 140 via connections 101 and with network(s) 110 and components therein via connections 201.

FIG. 2 illustrates a single IAB donor 200 connected to the core network 202. The IAB donor 200 has a centralized unit control plane (CU-CP) 204, a centralized unit user plane (CU-CU) 206 and other functions 208. The IAB donor 200 may serve three direct IAB child nodes 210₁-210₃ (collectively 210) through two collocated DUs 212 at the donor for wireless backhauling. The center IAB node 2102 in turn serves two IAB nodes 210₄, 210₅ through a wireless backhaul. All IAB nodes 204 in the figure backhauls traffic both related to UEs connected to it, and other backhaul traffic from downstream IAB nodes.

Certain challenges of conventional approaches including defining procedures for migration/topology adaptation to enable IAB-node mobility, including inter-donor migration of the entire mobile IAB-node (full migration) [RAN3, RAN2]. Enhancements for mobility of an IAB-node together with its served UEs, including aspects related to group mobility may be beneficial with no optimizations for the targeting of surrounding UEs. [RAN3, RAN2]. Solutions should avoid topics where Rel-17 discussions already occurred and where the topic was excluded from Rel-17, except for enhancements that are specific to IAB-node mobility. Solutions should provide mitigation of interference due to IAB-node mobility, including the avoidance of potential reference and control signal collisions (e.g., PCI, RACH). [RAN3, RAN2]. The following principles should be respected: mobile IAB-nodes should be able to serve legacy UEs and solutions providing optimization for Mobile IAB may entail Rel-18 UE enhancements, provided that such enhancements are backwards compatible.

### SUMMARY

Certain aspects of the disclosure and their embodiments may provide solutions to these or other challenges. Some embodiments are directed to methods at the user equipment (UE) that is served by a mobile IAB and which RRC status is RRC_IDLE or RRC_INACTIVE. Operations according to such methods include receiving from the mobile IAB a first indication that the UEs in RRC_CONNECTED connected to the same mobile IAB are initiating or have initiated a handover procedure to a target cell. Operations may further include receiving a second indication about to which target cell the UEs in RRC_CONNECTED have been handed off. Some embodiments are directed to methods at the mobile IAB that has or will initiate a handover procedure for its UEs in RRC_CONNECTED. Such methods may include operations including transmitting a first message to the UEs in RRC_IDLE and/or RRC_INACTIVE. In some embodiments, the message includes an indication that the UEs in RRC_CONNECTED connected to the same mobile IAB are initiating (or have initiated) and handover procedure to a target cell. Operations may include receiving a message from a UE with a connection request via a random access plus radio resource control, RRC, setup or RRC resume procedure) in order to transit to the RRC_CONNECTED state and transmitting a message to the CU that is hosting the target cell (in case the target cell is not hosted by the mobile IAB but by a new mobile IAB or a new network node). In some embodiments, the message comprises one or more of the UE context of all the UEs in RRC_INACTIVE to which have been indicated that the target cell should be their new serving cell or the cell in which they are camping, and an indication whether it has been indicated to the UE to perform the RNA update or tracking area procedure. In some embodiments, the indication may include a request to provide a random access configuration to be used by the UE when establishing a new connection towards the target cell and/or a request to provide a configuration to be sent to the UE. Some embodiments provide receiving a message from the CU that is hosting the target cell (in case the target cell is not hosted by the mobile IAB but by a new mobile IAB or a new network node). In some embodiments, the message may include one or more of: a random access configuration to be sent to and used by the UE when establishing a new connection towards the target cell, and a configuration such as a handover command to be sent to and used by the UE. Operations may include transmitting a second message to the UE that is RRC_CONNECTED. In some embodiments, the message includes one or more of a handover command to switch to a target cell, an indication about to which target cell the UEs in RRC_CONNECTED have been handed off, and a configuration to be used by the UE to perform random access in the indicated target cell.

Certain embodiments may provide one or more of the following technical advantage(s). The methods and solutions disclosed herein allow the mobile to indicate to the UEs in RRC_IDLE and RRC_INACTIVE under its coverage that a cell change has been initiated or performed. The current cell may not serve the UE any longer and the methods here by specified would force the UE to migrate/move to new cell.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic block diagram illustrating network communication according to some embodiments of network operations and components;

FIG. 2 is a schematic block diagram illustrating a basic architecture of IAN;

FIG. 3 is a schematic block diagram illustrating a mobile IAB-node that involves intra-donor, inter-donor (same CU) and inter CUs according to some embodiments;

FIG. 4 is a schematic block diagram illustrating scenarios in which a mobile IAB changes CU according to some embodiments;

FIG. 5 is a flow chart illustrating operations at a UE that is served by a mobile IAB according to some embodiments of inventive concepts;

FIG. 6 is a flow chart illustrating operations at a mobile IAB that will initiate handover procedure for its EU's according to some embodiments of inventive concepts;

FIG. 7 is a block diagram of a communication system in accordance with some embodiments;

FIG. 8 is a block diagram of a user equipment in accordance with some embodiments;

FIG. 9 is a block diagram of a network node in accordance with some embodiments;

FIG. 10 is a block diagram of a host, which may be an embodiment of the host of FIG. 7, in accordance with some embodiments;

FIG. 11 is a block diagram of a virtualization environment in accordance with some embodiments; and

FIG. 12 shows a communication diagram of a host communicating via a network node with a user equipment over a partially wireless connection in accordance with some embodiments.

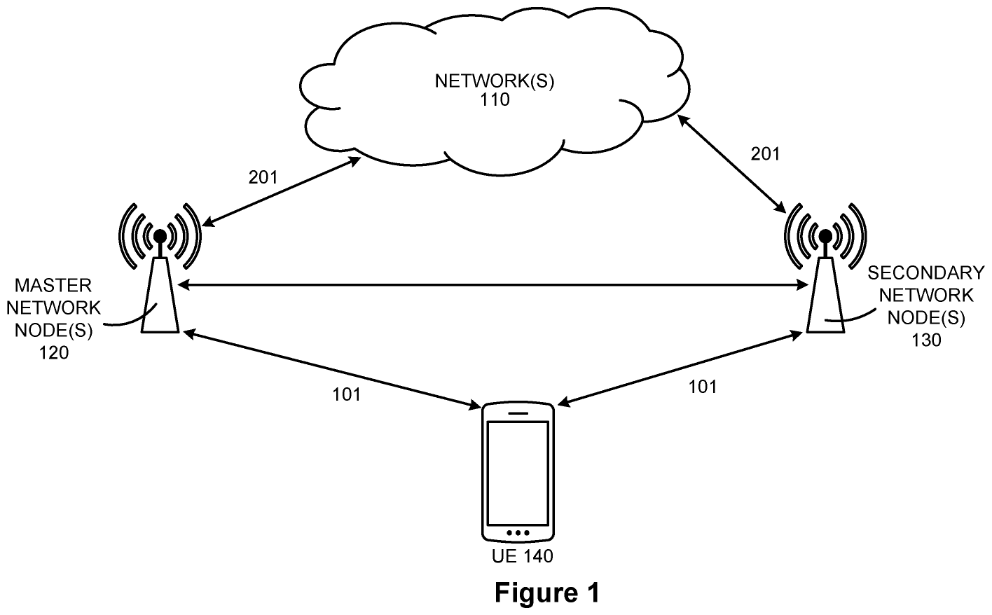

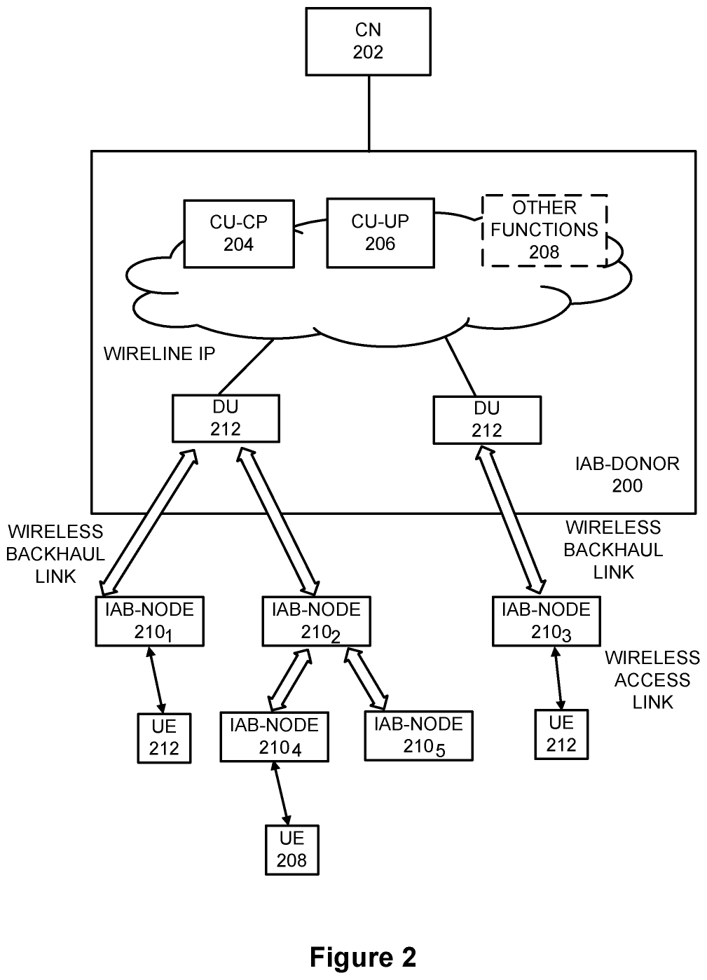

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, methods and solutions disclosed herein allow the mobile to indicate to the UEs in RRC_IDLE and RRC_INACTIVE under its coverage that a cell change has been initiated or performed.

According to some embodiments, the main components of IAB architecture may be an IAB Node, which is a node that allows wireless access to the UEs while also backhauling the traffic to other nodes. The IAB node may include a DU that provides access to connected UEs. The node also consists of a mobile termination (MT) that connects to other IAB nodes or donors in the uplink direction for backhaul.

Some embodiments provide that components include an IAB Donor, which is a node that provides UEs an interface to the core network and wireless functionality to other IAB-nodes to backhaul their traffic to the core network.

The defining feature of IAB may be the use of wireless spectrum for both access of UEs and backhauling of data through IAB donors. Thus, a clear separation of access and backhaul resources may be needed to avoid interference between them. This separation of access and backhaul resources may not be handled during network planning due to dynamic nature of IAB.

In one release, IAB was standardized with basic support for multi-hop multi-path backhaul for directed acyclic graph (DAG) topology and no mesh-based topology was supported. Such release may also support QoS prioritization of backhaul traffic and flexible resource usage between access and backhaul. Current discussions in another release are on topology enhancements for IAB with partial migration of IAB nodes for RLF recovery and load balancing.

Other information regarding already standardized IAB work may include: Madapatha, Charitha et al. “On Integrated Access and Backhaul Networks: Current Status and Potentials.” IEEE Open Journal of the Communications Society 1 (2020): 1374-1389; 3GPP TS 38.300. Section 4.7; and 3GPP TR 38.874 Study on IAB.

In another release, it is expected that the different RAN groups will work towards enhancing functionality of IAB through: focus on mobile-IAB/vehicle mounted relays (VMR) providing 5G coverage enhancement to onboard and surrounding Ues; and smart repeaters that build on LTE-repeaters.

The initial use cases for mobile-IAB/VMR may be expected to be based on 3GPP TR 22.839. One of the main use cases of mobile IAB cell is to serve the UEs that are residing in the vehicle with the vehicle mounted relay and integrated access backhaul solutions. Other relevant use cases for mobile IABs involve a mobile/nomadic IAB network node mounted on a vehicle that provides extended coverage. This involves scenarios where additional coverage is required during special events like concerts, during disasters. The nomadic IAB node provides access to surrounding UEs while the backhaul traffic from the nomadic IAB node is then transmitted wirelessly either with the help of IAB donors or non-terrestrial networks (NTN). A nomadic IAB node also reduces or even eliminates signal strength loss due to vehicle penetration for UEs that are present in the vehicles.

Advantages of mobile IAB may include reducing/eliminating the vehicle penetration loss (specially at high frequency) and reducing/eliminating group handover.

The F1 interface may connect the CU to the DU in the split architecture, which may also be applicable to the IAB architecture. The F1 interface connects the CU from an IAB donor to IAB DU in the child IAB nodes. The F1 interface also supports control and user plane separation through F1-C and F1-U respectively.

This interface holds even during IAB mobility where an IAB node moves and connects to parent/donor IAB nodes. In such a scenario the DU present in the mobile IAB node connects to the CU present in the IAB donor.

The IAB-DU may initiate a F1 setup with the IAB-CU with which it has a TNL connection and the initial F1 setup is shown below from section 8.5 of 38.401. Once the F1 setup is completed, the IAB donor CU sends a GNB-CU CONFIGURATION UPDATE to optionally indicate the DU cells to be activated.

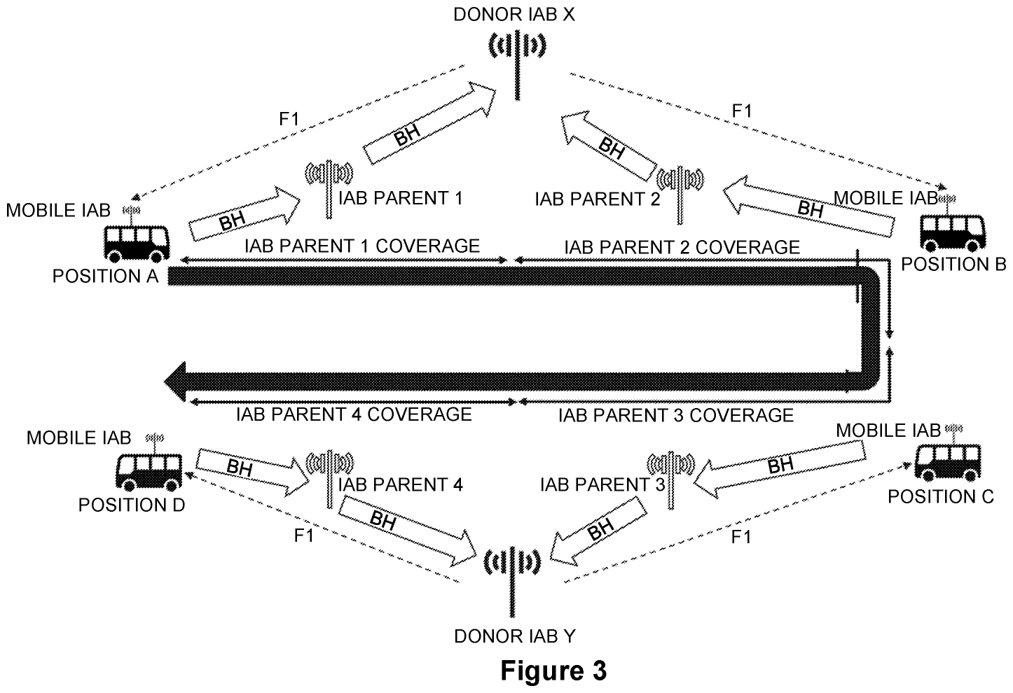

Consider that in most use cases of mobile IAB, it is expected to be mounted on public transport vehicles and to move to a large extent in a pre-determined route. Brief reference is now made to FIG. 3, which is a schematic block diagram illustrating a mobile IAB-node that involves intra-donor, inter-donor (same CU) and inter CUs according to some embodiments. As illustrated, one such mobile IAB mounted on a bus travelling on a route from position A to position D and that is covered by 4 different stationary parent IAB nodes (IAB parent node 1 having IAB parent node 1 coverage, IAB parent node 2 having IAB parent node 2 coverage, IAB parent node 3 having IAB parent node 3 coverage, and IAB parent node 4 having IAB parent node 4 coverage) as the bus travels on the route. The parent nodes backhaul their traffic through 2 donor nodes (IAB donor X, IAB donor Y).

An IAB node has a DU that provides access to UEs around it and an MT that provides a backhaul connection of the IAB node to its parent(s) and the rest of the network. The parent IAB nodes consist of DUs that provide access to UEs and the mobile IAB present in their coverage. They also consist of MTs that backhaul its traffic together with traffic from the mobile IAB node. Finally, the two donor nodes consist of DU that provides access and CU that is connected to the core network. The CUs in both donor nodes maintain a F1 connection to parent nodes under it.

The mobile IAB node maintains an F1 connection to the donor (one donor at a time). In the figure, the mobile IAB connects to the following nodes in the different positions as described below:
1) Position A: BH through IAB parent node 1, F1 connection to IAB donor node X;
2) Position B: BH through IAB parent node 2, F1 connection to IAB donor node X;
3) Position C: BH through IAB parent node 3, F1 connection to IAB donor node Y; and
4) Position D: BH through IAB parent node 4, F1 connection to IAB donor node Y.
The mobile IAB may change the F1 connection from donor X to donor Y when moving from position B to C, thus requiring a F1 handover and setup of backhaul RLC channels.

Some embodiments provide that RAN4 may study impact on RF and RRM requirements including conducting co-existence study to assess the impact of moving cells. Based on the study outcome, RF and RRM requirements and mechanisms may be specified for the mobile IAB-node to enable co-existence, if needed. Additionally, RRM requirements may be specified for the mobile IAB-node to enable IAB-node mobility, if needed.

According to the objective of the WID, one of the aspects that may need to be standardized and eventually enhanced is how the UEs connected to a mobile IAB are handed off in case e.g., the mobile IAB switches from one donor CU to another donor CU. In such a case, we have a special situation because the UEs served by the mobile IAB do not really change cell (since they are still in the coverage of the same mobile IAB). However, they eventually would need to update or reconfigure some parameter so that they are in line with what the new CU has configured.

In this situation, one particular aspect that needs to be addressed is how to handle those UEs that are physically inside the vehicle in which the mobile IAB is mounted but that are not in RRC_CONNECTED state (i.e., thus they are in RRC_IDLE or RRC_INACTIVE).

In case the current RRC procedures are applied, those UEs in RRC_IDLE and RRC_INACTIVE once figuring out that the cell in which they are camping has changed, they will trigger a cell (re) selection procedure in order to (re) select a new cell (that also for sure will be the same mobile IAB). This is a particular situation as the mobile IAB in which they are camping has not really changed but since some parameter of the cell hosted by the mobile IAB have changed (because the CU has changed) these UEs will see this cell as a totally new cell with new cell ID, PCI or frequency.

Now, while for the RRC_IDLE UEs legacy RRC procedure, even if not working properly, may be still tolerable, for the UEs in RRC_INACTIVE the problems are more severe. In fact, once figuring out that the cell in which they are camping as changed, all of them will trigger (almost at the same time) an RAN-Notification Area Update (RNAU) procedure thus causing a signaling overhead at the network. The consequence may be that the network will not be able to handle all this huge number of RRC messages received in a very short time and thus some of the UEs may be sent to RRC_IDLE.

The methods and solutions disclosed herein allow the mobile to indicate to the UEs in RRC_IDLE and RRC_INACTIVE under its coverage that an handover has been initiated or performed since the mobile IAB has switched from one CU to another CU. In particular, the following solution can be used. When the mobile IAB initiates an handover procedure for the UEs in RRC_CONNECTED, the mobile IAB informs all the UEs in RRC_IDLE and/or RRC_INACTIVE under its coverage that this handover is started or going to happen or has triggered/initiated and in some cases after the Handover has been completed. The way these UEs in RRC_IDLE and/or RRC_INACTIVE are informed by the mobile IAB may be according to one or more of the following options.

The first option provides that the mobile IAB sends a broadcast message (i.e., within a system information block-SIB) an indication that an handover for the UEs in RRC_CONNECTED has been initiated. In some embodiments, in the broadcast message, one or more of the following info may be contained the cell (or a list of cells) in which the UEs in RRC_CONNECTED have been handed off. In some embodiments, a configuration for the UEs in RRC_IDLE and/or RRC_INACTIVE may indicate those UE to switch to a target cell. Here switching to a target cell means performing the Random Access procedure towards that indicated target cell. Some embodiments include an indication for the UEs to transit to RRC_CONNECTED and once this is done sending a configuration to trigger the handover of these UE to a new selected target cell.

Some embodiments provide that the mobile IAB pages the UEs in RRC_IDLE and/or RRC_INACTIVE to indicate that an handover for the UEs in RRC_CONNECTED has been initiated. In some embodiments, when paging the UEs in RRC_IDLE and/or RRC_INACTIVE, the mobile IAB may pursue one or more of the following actions: indicate the cell (or list of cells) to which the UEs in RRC_CONNECTED have been handed off; indicate to the UEs to transit to RRC_CONNECTED and after the UEs transit to RRC_CONNECTED then sending an handover command to initiate the handover also for those UE.

In some embodiments, the system info broadcast from mobile IAB cell updates the RAN Area Code. The update can be temporary or permanent. The RAN area code update would cause the UE which are in RRC Inactive to perform resume procedure, and this would lead to UE context migration.

Some embodiments provide that the system info broadcast from mobile IAB cell updates the Tracking Area Code (TAC). The update can be temporary or permanent. The TAC update would cause the UE in RRC Idle mode to perform registration procedure. The registration procedure by itself will not solve the problem. But it is expected that the UE may wake up and perform cell reselection.

In some embodiments, the system info broadcast from mobile IAB cell updates the cell suitability criteria such that UEs in idle mode find the current cell unsuitable and perform cell reselection.

Some embodiments provide that the cell reselection measurement parameters are updated so that UE is forced to perform cell reselection; e.g.: making it harder for the UE to fulfil the following conditions.

In some embodiments, if the serving cell fulfils Srxlev>S_{IntraSearchP} and Squal>S_{IntraSearchQ}.

In some embodiments, the scenario we target is when a mobile IAB node is mounted in a vehicle (in the inside or outside part of it) and one or several UEs should connect to the mobile IAB only when located inside the vehicle (e.g., a bus). Some embodiments provide that the terms “m-IAB”, “mobile IAB” and “m-IAB node” may be used interchangeably. Some embodiments provide that the terminology “UE connected to a mobile IAB” characterizes a UE that is physically inside the vehicle in which the mobile IAB node is mounted.

In some embodiments, handover of the UE served by the mobile IAB can be triggered either when a UE is not located anymore in the vehicle in which the mobile IAB is mounted or when the mobile IAB goes from the coverage of one donor CU to another donor CU. For this latter case, the handover of the UE served by the mobile IAB can be triggered either when the mIAB-MT switches from one donor CU to another donor CU or when the F1 link of the mIAB-DU is relocated from one donor CU to another donor CU.

As provided herein, we refer to “source node” as the network node in which the UE is currently operating. Also, we refer to a “target node” as the network node in which the UE perform the handover. Some embodiments provide that the source node is the mobile IAB node while the target node may be the existing or a new mobile IAB node or a normal static node.

In some embodiments, the radio access network area code update is based upon TS 38.331 vs 17.1.0.

In some embodiments, the IE RAN-AreaCode is used to identify a RAN area within the scope of a tracking area. In some embodiments, the RAN-AreaCode information element is determined as:

| --ASN1START | |
|---|---|
| --TAG-RAN-AREACODE-START | |
| RAN-AreaCode::= | INTEGER (0..255) |

--TAG-RAN-AREACODE-STOP
--ASN1STOP

In some embodiments, tracking area code is based upon TS 38.331 Vs17.1.0. Some embodiments provide that the IE TrackingAreaCode is used to identify a tracking area within the scope of a PLMN/SNPN, see TS 24.501. In some embodiments, the tracking area code information element may be provided as:

--ASN1START
--TAG-TRACKINGAREACODE-START
TrackingAreaCode::=BIT STRING (SIZE (24))
--TAG-TRACKINGAREACODE-STOP
-- ASN1STOP

The cell suitable criteria may be defined in TS 38.304. Specifically, the cell selection criterion S is fulfilled when:

$$Srxlev > 0$$

$$AND$$

$$Squal > 0$$

$$where :$$

$$Srxlev = {Q}_{rxlevmeas} - ( {Q}_{rxlevmin} + {Q}_{rxlevminoffset} ) - {P}_{compensation} - {Qoffset}_{t e m p}$$

$$Squal = {Q}_{qualmeas} - ( {Q}_{qualmin} + {Q}_{qualminoffset} ) - {Qoffset}_{temp}$$

where: the cell suitable criteria may be defined in TS 38.304. Specifically, the cell selection criterion S is fulfilled when:

$$Srxlev > 0$$

$$AND$$

$$Squal > 0$$

$$where :$$

$$Srxlev = {Q}_{rxlevmeas} - ( {Q}_{rxlevmin} + {Q}_{rxlevminoffset} ) - {P}_{compensation} - {Qoffset}_{t e m p}$$

$$Squal = {Q}_{qualmeas} - ( {Q}_{qualmin} + {Q}_{qualminoffset} ) - {Qoffset}_{temp}$$

where:

| | |
|---|---|
| Srxlev | Cell selection RX level value (dB) |
| Squal | Cell selection quality value (dB) |
| Qoffsetₜₑₘₚ | Offset temporarily applied to a cell as specified in TS |
| | 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qᵣₓₗₑᵥₘᵢₙ is obtained |
| | from q-RxLevMinSUL, if present, in SIB1, SIB2 and SIB4, |
| | additionally, if Q_{rxlevminoffsetcellSUL} is present in SIB3 and |
| | SIB4 for the concerned cell, this cell specific offset is |
| | added to the corresponding Qrxlevmin to achieve the |
| | required minimum RX level in the concerned cell; |
| | else Qᵣₓₗₑᵥₘᵢₙ is obtained from q-RxLevMin in SIB1, SIB2 |
| | and SIB4, additionally, if Q_{rxlevminoffsetcell} is present in SIB3 |
| | and SIB4 for the concerned cell, this cell specific offset is |
| | added to the corresponding Qrxlevmin to achieve the |
| | required minimum RX level in the concerned cell. |
| Q_{qualmin} | Minimum required quality level in the cell (dB). |
| | Additionally, if Q_{qualminoffsetcell} is signalled for the |
| | concerned cell, this cell specific offset is added to achieve |
| | the required minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN, as specified in TS 23.122 [9]. |
| Q_{qualminoffset} | Offset to the signalled Q_{qualmin} taken into account in the |
| | Squal evaluation as a result of a periodic search for a |
| | higher priority PLMN while camped normally in a |
| | VPLMN, as specified in TS 23.122 [9]. |
| P_{compensation} | For FR1, if the UE supports the additionalPmax in the |
| | NR-NS-PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, | Maximum TX power level of a UE may use when |
| P_{EMAX2} | transmitting on the uplink in the cell (dBm) defined as |
| | P_{EMAX} in TS 38.101 [15]. If UE supports SUL frequency |
| | for this cell, P_{EMAX1} and P_{EMAX2} are obtained from the p- |
| | Max for SUL in SIB1 and NR-NS-PmaxList for SUL |
| | respectively in SIB1, SIB2 and SIB4 as specified in TS |
| | 38.331 [3], else P_{EMAX1} and P_{EMAX2} are obtained from the |
| | p-Max and NR-NS-PmaxList respectively in SIB1, SIB2 |
| | and SIB4 for normal UL as specified in TS 38.331 [3]. |
| P_{PowerClass} | Maximum RF output power of the UE (dBm) according |
| | to the UE power class as defined in TS 38.101-1 [15]. |

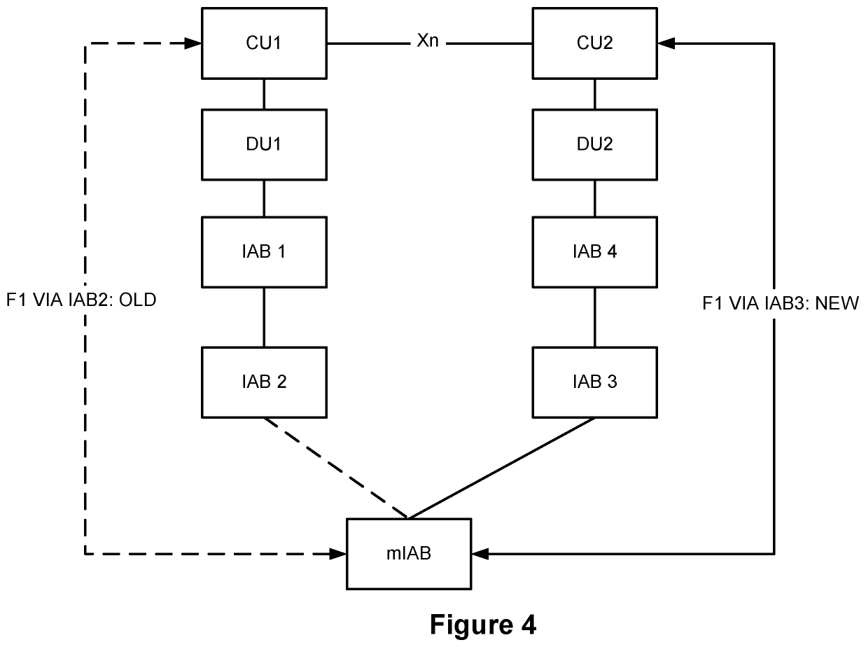

Brief reference is now made to FIG. 4, which is a schematic block diagram illustrating scenarios in which a mobile IAB changes CU according to some embodiments. In FIG. 4, the mIAB is shown moving from CU1 to CU2. In such embodiments, shown is the scenario in which F1 has to be relocated or mIAB has to reconfigure the PCI (change the PCI) because of PCI collision. If mobile IAB happens to move to area with the same PCI as the mobile IAB cells PCI then the mobile IAB cells (PCI value) may require to be changed.

In some embodiments, the embodiments disclosed herein may provide the mechanism for UEs in RRC Idle and RRC Inactive to perform the cell change in an efficient way. For the UE in RRC Inactive mode to move its UE context from CU1 to CU2 in case of CU handover.

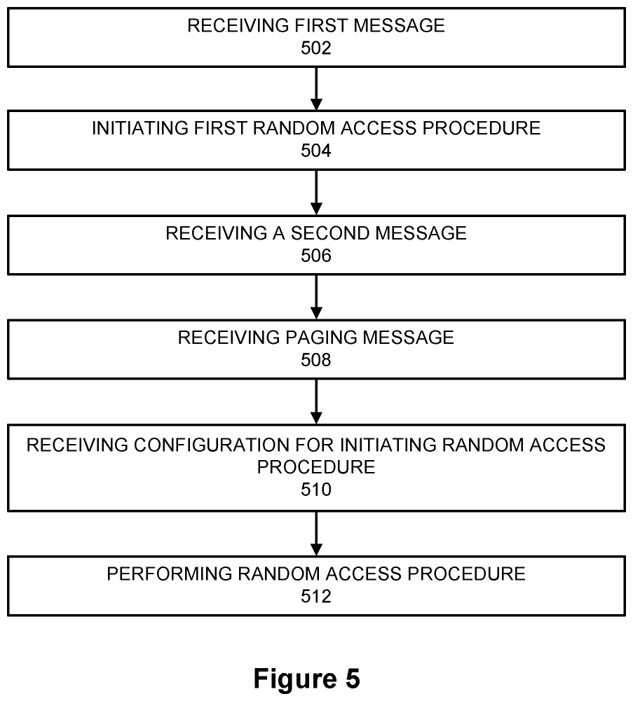

Reference is now made to FIG. 5, which is a flow chart illustrating operations at a UE that is served by a mobile IAB according to some embodiments of inventive concepts. In some embodiments, a method at the user equipment (UE) that is served by a mobile IAB and which RRC status is RRC_IDLE or RRC_INACTIVE, includes receiving (block 502) a first message from the mobile IAB. In some embodiments, the message includes an indication that the UEs in RRC_CONNECTED connected to the same mobile IAB are initiating (or have initiated) and handover procedure to a target cell.

Operations may include initiating (block 504) a first random access procedure towards the mobile IAB to transit to RRC_CONNECTED and receiving (block 506) a second message from the mobile IAB. In some embodiments, the second message may comprise one or more of: a handover command to switch to a target cell, an indication about to which target cell the UEs in RRC_CONNECTED have been handed off, and a configuration to be used by the UE to perform random access in the indicated target cell.

In some embodiments, the UE is configured to go back to RRC_IDLE or RRC_INACTIVE first, and then trigger the random access procedure toward the indicated target cell. Some embodiments provide that, responsive to receiving the second message from the mobile IAB operations may include one or more of initiating a handover procedure to the indicated target cell and going to RRC_IDLE or RRC_INACTIVE and then initiating a second random access procedure towards the indicated target cell.

Some embodiments include receiving, by the UE, the first message from the mobile IAB via a broadcasted message comprising a system information block (SIB).

Some embodiments include receiving (block 508), by the UE, the first message from the mobile IAB via a group signaling that includes a paging message.

In some embodiments may include receiving, by the UE, the second message from the source node via a dedicate RRC message via a MAC CE, via L1 signaling.

In some embodiments, the second message received by the UE from the mobile IAB via a broadcasted message including a system information block (SIB).

In some embodiments, the UE does not perform the random access procedure after receiving the first message and stays in RRC_IDLE or RRC_INACTIVE. Some embodiments provide that the first message includes one or more of a cell in which the other UEs in RRC_CONNECTED have been handed off and a configuration that the UE needs to use to switch to the indicated target cell. In some embodiments, responsive to switching to a target cell, the UE does not perform a cell selection or a cell reselection procedure and directly performs the Random Access procedure towards that indicated target cell. Some embodiments provide that an indication for the UE to transit to RRC_CONNECTED includes a simple one-bit indication and/or additional information comprising a configuration so to make easier the random access procedure of the UE towards the mobile IAB. Some embodiments include an indication on whether to perform the RNA update or tracking area update procedure towards the indicated target cell.

Some embodiments include receiving (block 508) the paging message of at least one of the mobile IAB (RAN-paging) and the AMF to which the mobile IAB is connected.

In some embodiments, the second message received by the mobile IAB includes one or more of a cell in which the UEs in RRC_CONNECTED have been handed off, a configuration for the UEs in RRC_IDLE and/or RRC_INACTIVE that indicate those UE to switch to a target cell, and an indication for the UE to trigger a handover procedure towards a selected target cell.

In some embodiments, the indication includes a configuration for the UE to be used in the target cell once the handover has been completed. In some embodiments, switching to a target cell includes performing the Random Access procedure towards that indicated target cell. In some embodiments, the configuration further includes an indication on whether to perform the RNA update or tracking area update procedure towards the indicated target cell.

Some embodiments include receiving (block 510), by the UE, a configuration for initiating a random access procedure towards an indicated target cell comprising the RRC_IDLE or RRC_INACTIVE and then performing (block 512) the random access procedure towards the indicated target cell. Some embodiments provide that the UE does not perform a cell selection procedure or a cell reselection procedure as the cell to which the UE will establish a new connection that is already indicated by the mobile IAB.

In some embodiments, responsive to receiving, by the UE, an indication that the other UEs in RRC_CONNECTED have been handed off to a target cell, the UE considers the target cell as its new cell in which it is camping and does not trigger any RNA update or tracking area procedure. Some embodiments provide that the coverage of a new cell uses the existing configuration to operate in that cell while in RRC_IDLE or RRC_INACTIVE.

In some embodiments, the target cell includes a cell that is hosted by the same mobile IAB.

Some embodiments provide that the UE does not physically leave the bus when going from the source cell by the target cell.

In some embodiments, the first or second RRC message received by the mobile IAB includes an updated RAN Area code, an updated TAC; an updated Cell Suitability and an updated cell reselection criterion. In some embodiments, the UE may be triggered to perform at least one of a RNAU procedure, a TAU procedure, and a cell (re) selection procedure.

In some embodiments, the system information blocks broadcasted from mobile IAB include cell updates comprising the cell suitability criteria, and wherein the UEs in RRC IDLE find the current cell unsuitable and perform cell reselection. Some embodiments provide that the cell reselection measurement parameters are updates so that UE is forced to perform cell reselection which makes it harder for the UE to fulfil the conditions of Srxlev>S_{IntraSearchP} and Squal>S_{IntraSearchQ}.

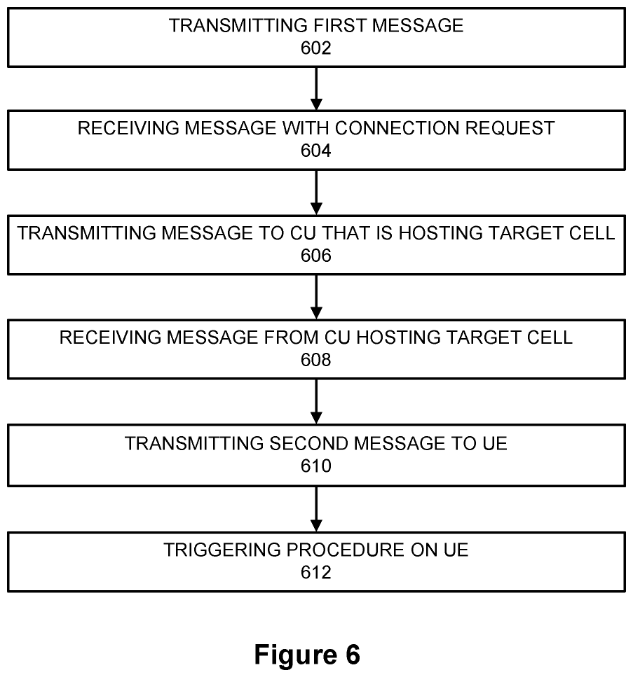

Reference is now made to FIG. 6, which is a flow chart illustrating operations at a mobile IAB that will initiate handover procedure for its EU's according to some embodiments of inventive concepts.

Some embodiments include methods at the mobile IAB that have or will initiate an handover procedure for its UEs in RRC_CONNECTED. Operations corresponding to such methods include transmitting (block 602) a first message to the UEs in RRC_IDLE and/or RRC_INACTIVE. In some embodiments, the message includes an indication that the UEs in RRC_CONNECTED connected to the same mobile IAB are initiating (or have initiated) and handover procedure to a target cell.

Operations include receiving (block 604) a message from the UE with a connection request (via the random access plus RRC setup or RRC resume procedure) in order to transit to the RRC_CONNECTED state.

Operations may include transmitting (block 606) a message to the CU that is hosting the target cell (in case the target cell is not hosted by the mobile IAB but by a new mobile IAB or a new network node). In some embodiments, the message includes one or more of the UE context of all the UEs in RRC_INACTIVE to which have been indicated that the target cell should be their new serving cell or the cell in which they are camping, an indication whether it has been indicated to the UE to perform the RNA update or tracking area procedure, a request to provide a random access configuration to be used by the UE when establishing a new connection towards the target cell operating in a certain carrier frequency, and a request to provide a configuration to be sent to the UE.

Operations include receiving (block 608) a message from the CU that is hosting the target cell (in case the target cell is not hosted by the mobile IAB but by a new mobile IAB or a new network node). In some embodiments, the message may include one or more of a random access configuration to be sent to and used by the UE when establishing a new connection towards the target cell, and a configuration such as a handover command to be sent to and used by the UE to connect to the target cell operating in a certain carrier frequency.

Operations include transmitting (block 610) a second message to the UE that is RRC_CONNECTED. In some embodiments the message includes one or more of a handover command to switch to a target cell, an indication about to which target cell the UEs in RRC_CONNECTED have been handed off, and a configuration to be used by the UE to perform random access in the indicated target cell.

In some embodiments, the UE goes back to RRC_IDLE or RRC_INACTIVE first, and then triggers the random access procedure toward the indicated target cell.

Some embodiments provide that the configuration includes a random access configuration plus a set of configurations to be used once the random access has been performed.

In some embodiments, the UEs in RRC_INACTIVE will not perform any RNA update or tracking area procedure after receiving the indication that the cell in which they are camping has changed.

In some embodiments, the configuration includes a random access configuration plus a set of configurations to be used once the random access has been performed.

In some embodiments, the first message sent to the UE is done via a broadcasted message including a system information block (SIB).

In some embodiments, the first message sent to the UE is done via a group signaling comprising a paging message.

Some embodiments provide that the second message sent to the UE is done via a new or existing dedicate RRC message via a MAC CE, via L1 signaling.

In some embodiments, the second message is sent to the UE via a broadcasted message including a system information block (SIB). Some embodiments provide that the UE does not perform the random access procedure to transit to RRC_CONNED after receiving the first message but stays in RRC_IDLE or RRC_INACTIVE.

In some embodiments, the first message includes one or more of a cell or a list of cells in which the other UEs in RRC_CONNECTED have been handed off and a configuration that the UE needs to use to switch to the indicated target cell. Some embodiments provide that switching to a target cell means that the UE does not perform any cell (re) selection procedure and directly performs the Random Access procedure towards that indicated target cell. In some embodiments, the first message includes an indication for the UE to transit to RRC_CONNECTED and an indication on whether to perform the RNA update or tracking area update procedure towards the indicated target cell. In some embodiments, the indication includes a simple one-bit indication and/or additional information including a configuration to make the random access procedure of the UE towards the mobile IAB easier.

In some embodiments, the paging message is sent directly by the mobile IAB by RAN-paging or a request to the AMF in which the mobile IAB is connected is sent in order to trigger a paging message from the AMF for core network paging to the UE.

Some embodiments provide that operations include receiving, by the mobile IAB, the second message that includes a cell or a list of cells in which the UEs in RRC_CONNECTED have been handed off and a configuration for the UEs in RRC_IDLE and/or RRC_INACTIVE that indicate those UE to switch to a target cell. In some embodiments, switching to a target cell includes performing the Random Access procedure towards that indicated target cell. Some embodiments provide an indication on whether to perform the RNA update or tracking area update procedure towards the indicated target cell. Some embodiments provide an indication for the UE to trigger a handover procedure towards a selected target cell. In some embodiments, the indication includes a configuration for the UE to be used in the target cell once the handover has been completed.

In some embodiments, the first or second RRC message received by the mobile IAB includes at least one of an updated RAN Area code, an updated TAC, an updated Cell Suitability and an updated cell reselection criterion.

Operations may include triggering (block 612) on the UE at least one of a RNAU procedure, a TAU procedure, and a cell selection procedure.

In some embodiments, the system information blocks broadcasted from mobile IAB include cell updates such as the cell suitability criteria. Some embodiments provide that UEs in RRC_IDLE find the current cell unsuitable and perform cell reselection. In some embodiments, the cell reselection measurement parameters are updates so that the UE is forced to perform cell reselection that makes it harder for the UE to fulfil conditions of the serving cell fulfilling Srxlev>SIntraSearchP and Squal>SIntraSearchQ.

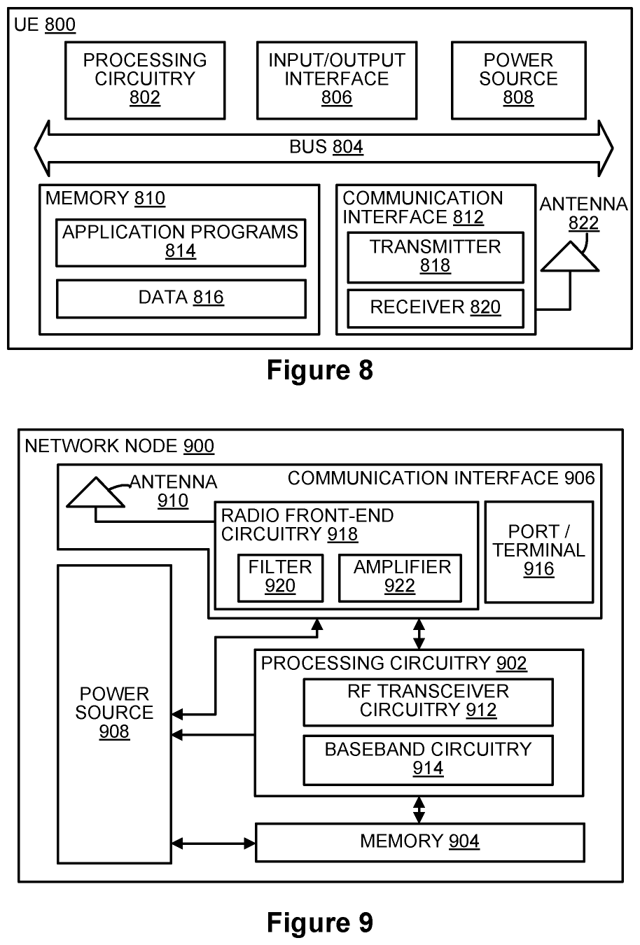

Operations of the communication device 800 (implemented using the structure of the block diagram of FIG. 8) will now be discussed with reference to the flow charts according to some embodiments of inventive concepts. For example, modules may be stored in memory 810 of FIG. 8, and these modules may provide instructions so that when the instructions of a module are executed by respective communication device processing circuitry 802, processing circuitry 802 performs respective operations of the flow chart.

Various operations from the flow chart of FIGS. 5 and 6 may be optional with respect to some embodiments of communication devices and related methods.

Operations of the RAN node 900 (implemented using the structure of FIG. 9) will now be discussed with reference to the flow chart of FIG. ______ according to some embodiments of inventive concepts. For example, modules may be stored in memory 904 of FIG. 9, and these modules may provide instructions so that when the instructions of a module are executed by respective RAN node processing circuitry 820, RAN node 900 performs respective operations of the flow chart.

Operations of the Core Network CN node 900 (implemented using the structure of FIG. 9) will now be discussed with reference to the flow chart of Figure according to some embodiments of inventive concepts. For example, modules may be stored in memory 904 of FIG. 9, and these modules may provide instructions so that when the instructions of a module are executed by respective CN node processing circuitry 902, CN node 900 performs respective operations of the flow chart.

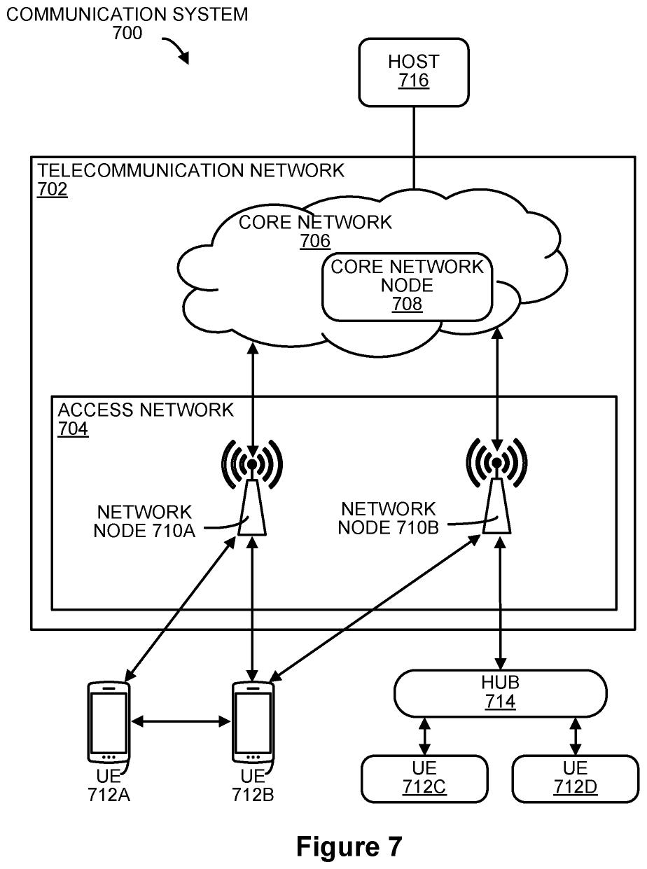

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

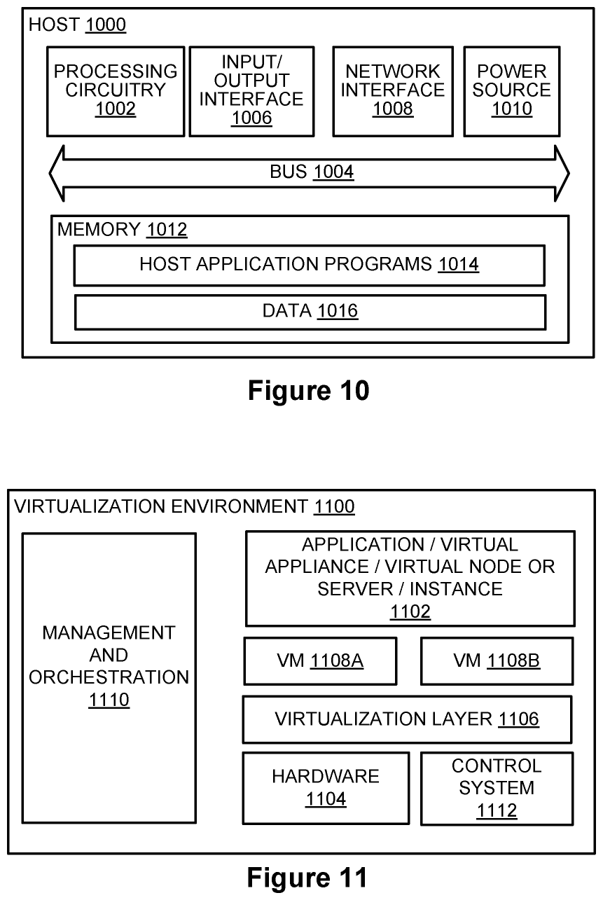

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

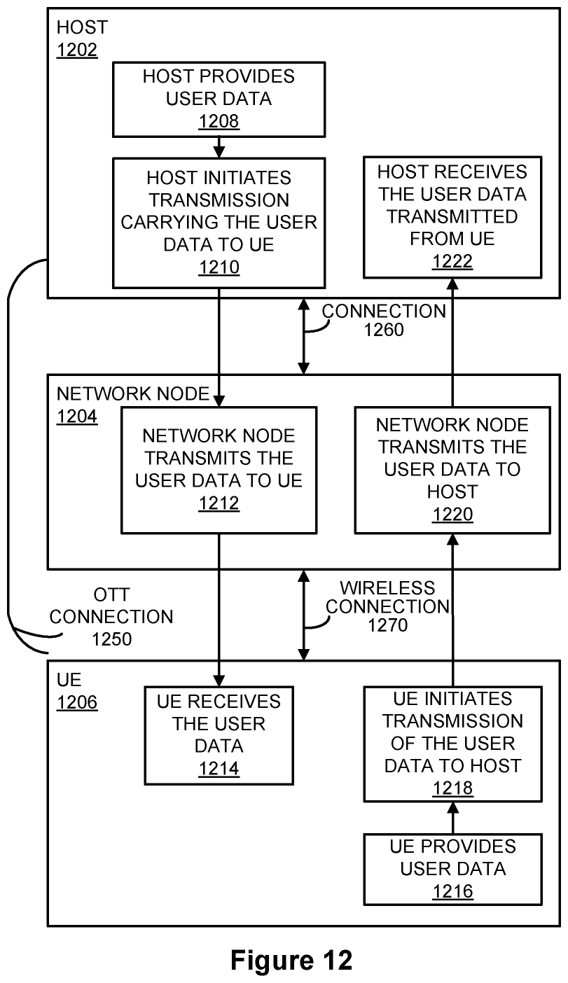

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve the mitigation of interference due to IAB mobility, including the avoidance of potential reference and control signal collisions (e.g., PCI (physical cell ID, RACH (Random Access Channel)).

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiments

### UE Method Embodiments

A1. A method at the user equipment (UE) that is served by a mobile IAB and which RRC status is RRC_IDLE or RRC_INACTIVE, the method comprising:
receiving a first message from the mobile IAB, wherein the message comprises an indication that the UEs in RRC_CONNECTED connected to the same mobile IAB are initiating (or have initiated) and handover procedure to a target cell; and
initiating a first random access procedure towards the mobile IAB to transit to RRC_CONNECTED; and
receiving a second message from the mobile IAB, wherein the second message may comprise one or more of the following:
a handover command to switch to a target cell;
an indication about to which target cell the UEs in RRC_CONNECTED have been handed off; and
a configuration to be used by the UE to perform random access in the indicated target cell.

A2. The method of embodiment A1, wherein the UE is configured to go back to RRC_IDLE or RRC_INACTIVE first, and then trigger the random access procedure toward the indicated target cell.

A3. The method of embodiment A2, wherein, responsive to receiving the second message from the mobile IAB operations further comprise at least one of:
initiating a handover procedure to the indicated target cell; and
going to RRC_IDLE or RRC_INACTIVE; and then initiating a second random access procedure towards the indicated target cell.

A4. A method of embodiment A1, further comprising receiving, by the UE, the first message from the mobile IAB via a broadcasted message comprising a system information block (SIB).

A5. A method of embodiment A1, further comprising receiving, by the UE, the first message from the mobile IAB via a group signaling comprising a paging message.

A6. A method of embodiment A1, further comprising receiving, by the UE, the second message from the source node via a dedicate RRC message via a MAC CE, via L1 signaling.

A7. A method of embodiment A1, further comprising receiving, by the UE, the second message from the mobile IAB via a broadcasted message comprising a system information block (SIB).

A8. A method of embodiment A1, wherein the UE does not perform the random access procedure after receiving the first message and stays in RRC_IDLE or RRC_INACTIVE.

A9. A method of embodiment A1, wherein the first message comprises one or more of: a cell in which the other UEs in RRC_CONNECTED have been handed off; and a configuration that the UE needs to use to switch to the indicated target cell.

A10. A method of embodiment A9, wherein responsive to switching to a target cell, the UE does not perform a cell selection or a cell reselection procedure and directly performs the Random Access procedure towards that indicated target cell.

A11. A method of embodiment A9, wherein an indication for the UE to transit to RRC_CONNECTED comprises a simple one-bit indication and/or additional information comprising a configuration so to make easier the random access procedure of the UE towards the mobile IAB.

A12. A method of embodiment A9, further comprising an indication on whether to perform the RNA update or tracking area update procedure towards the indicated target cell.

A13. A method of embodiments A1 and A3, further comprising receiving the paging message of at least one of the mobile IAB (RAN-paging) and the AMF to which the mobile IAB is connected.

A14. A method of embodiment A1, wherein the second message received by the mobile IAB comprises one or more of:
a cell in which the UEs in RRC_CONNECTED have been handed off;
a configuration for the UEs in RRC_IDLE and/or RRC_INACTIVE that indicate those UE to switch to a target cell; and
an indication for the UE to trigger a handover procedure towards a selected target cell.

A15. A method of embodiment A14, wherein the indication comprises a configuration for the UE to be used in the target cell once the handover has been completed.

A16. A method of embodiment 15, wherein switching to a target cell comprises performing the Random Access procedure towards that indicated target cell; and
wherein the configuration further comprises an indication on whether to perform the RNA update or tracking area update procedure towards the indicated target cell.

A17. A method of embodiment A15, further comprising receiving, by the UE, a configuration for initiating a random access procedure towards an indicated target cell comprising the RRC_IDLE or RRC_INACTIVE and then performing the random access procedure towards the indicated target cell; and
wherein the UE does not perform a cell selection procedure or a cell reselection procedure as the cell to which the UE will establish a new connection that is already indicated by the mobile IAB.

A18. A method of embodiments A1, A8, A9, wherein responsive to receiving, by the UE, an indication that the other UEs in RRC_CONNECTED have been handed off to a target cell, the UE considers the target cell as its new cell in which it is camping and does not trigger any RNA update or tracking area procedure.

A19. A method of embodiment A18, wherein the coverage of a new cell uses the existing configuration to operate in that cell while in RRC_IDLE or RRC_INACTIVE.

A20. A method of embodiment A1, wherein the target cell comprises a cell that is hosted by the same mobile IAB.

A21. A method of embodiment A20, wherein the UE does not physically leave the bus when going from the source cell by the target cell.

A22. A method of embodiment A1, wherein the first or second RRC message received by the mobile IAB comprises the following information:
an updated RAN Area code;
an updated TAC; an updated Cell Suitability; and
an updated cell reselection criterion.

A23. A method of embodiment A22, further comprising triggering the UE to perform at least one of a RNAU procedure, a TAU procedure, and a cell (re) selection procedure.

A24. A method of embodiments A1, A2, A5, A12, wherein the system information blocks broadcasted from mobile IAB comprise cell updates comprising the cell suitability criteria, and wherein the UEs in RRC_IDLE find the current cell unsuitable and perform cell reselection.

A25. A method of embodiment A24, wherein the cell reselection measurement parameters are updates so that UE is forced to perform cell reselection which makes it harder for the UE to fulfil the conditions of Srxlev>SIntraSearchP and Squal>SIntraSearchQ.

### Mobile IAB Method Embodiments

B1. A method at the mobile IAB that has or will initiate an handover procedure for its UEs in RRC_CONNECTED, the method comprising:
transmitting a first message to the UEs in RRC_IDLE and/or RRC_INACTIVE, wherein the message comprises an indication that the UEs in RRC_CONNECTED connected to the same mobile IAB are initiating (or have initiated) and handover procedure to a target cell;
receiving a message from the UE with a connection request (via the random access plus RRC setup or RRC resume procedure) in order to transit to the RRC_CONNECTED state; transmitting a message to the CU that is hosting the target cell (in case the target cell is not hosted by the mobile IAB but by a new mobile IAB or a new network node), wherein the message comprises one or more of:
the UE context of all the UEs in RRC_INACTIVE to which have been indicated that the target cell should be their new serving cell or the cell in which they are camping, an indication whether it has been indicated to the UE to perform the RNA update or tracking area procedure,
a request to provide a random access configuration to be used by the UE when establishing a new connection towards the target cell, and
a request to provide a configuration to be sent to the UE;
receiving a message from the CU that is hosting the target cell (in case the target cell is not hosted by the mobile IAB but by a new mobile IAB or a new network node), wherein the message may include one or more of: a random access configuration to be sent to and used by the UE when establishing a new connection towards the target cell, and a configuration such as a handover command to be sent to and used by the UE; and
transmitting a second message to the UE that is RRC_CONNECTED, wherein the message comprises one or more of: a handover command to switch to a target cell, an indication about to which target cell the UEs in RRC_CONNECTED have been handed off, and a configuration to be used by the UE to perform random access in the indicated target cell.

B2. The method of embodiment B1, wherein the UE goes back to RRC_IDLE or RRC_INACTIVE first, and then triggers the random access procedure toward the indicated target cell.

B3. The method of embodiment B1, wherein the configuration comprises a random access configuration plus a set of configurations to be used once the random access has been performed.

B4. The method of embodiment B1, wherein the UEs in RRC_INACTIVE will not perform any RNA update or tracking area procedure after receiving the indication that the cell in which there are camping has changed.

B5. The method of embodiment B1, wherein the configuration comprises a random access configuration plus a set of configurations to be used once the random access has been performed.

B6. A method of embodiment B1, wherein the first message sent to the UE is done via a broadcasted message comprising a system information block (SIB).

B7. A method of embodiment B1, wherein the first message sent to the UE is done via a group signaling comprising a paging message.

B8. A method of embodiment B1, wherein the second message sent to the UE is done via a new or existing dedicate RRC message via a MAC CE, via L1 signaling.

B9. A method of embodiment B1, wherein the second message is sent to the UE via a broadcasted message comprising a system information block (SIB).

B10. A method of embodiment B9, wherein the UE does not perform the random access procedure to transit to RRC_CONNED after receiving the first message but stay in RRC_IDLE or RRC_INACTIVE.

B11. A method of embodiment B1, wherein the first message comprises one or more of:
a cell or a list of cells in which the other UEs in RRC_CONNECTED have been handed off, and
a configuration that the UE needs to use to switch to the indicated target cell.

B12. A method of embodiment B11, wherein switching to a target cell means that the UE does not perform any cell (re) selection procedure and directly performs the Random Access procedure towards that indicated target cell.

B13. A method of embodiment B11, wherein the first message comprises: an indication for the UE to transit to RRC_CONNECTED; and
an indication on whether to perform the RNA update or tracking area update procedure towards the indicated target cell.

B14. A method of embodiment B13, wherein the indication comprises a simple one-bit indication and/or additional information comprising a configuration to make the random access procedure of the UE towards the mobile IAB easier.

B15. A method of embodiments B1 and B3, wherein the paging message is sent directly by the mobile IAB by RAN-paging or a request to the AMF in which the mobile IAB is connected is sent in order to trigger a paging message from the AMF for core network paging to the UE.

B16. A method of embodiment B1, further comprising receiving, by the mobile IAB, the second message that comprises:
a cell or a list of cells in which the UEs in RRC_CONNECTED have been handed off; a configuration for the UEs in RRC_IDLE and/or RRC_INACTIVE that indicate those UE to switch to a target cell.

B17. A method of embodiment B16, wherein switching to a target cell comprise performing the Random Access procedure towards that indicated target cell.

B18. A method of embodiment B16, further comprising an indication on whether to perform the RNA update or tracking area update procedure towards the indicated target cell.

B19. A method of embodiment B16, further comprising an indication for the UE to trigger an handover procedure towards a selected target cell, wherein the indication comprises a configuration for the UE to be used in the target cell once the handover has been completed.

B20. A method of embodiment B1, wherein the first or second RRC message received by the mobile IAB comprises at least one of: an updated RAN Area code, an updated TAC, an updated Cell Suitability and an updated cell reselection criterion.

B21. A method of embodiment B20, further comprising triggering on the UE at least one of a RNAU procedure, a TAU procedure, and a cell selection procedure.

B22. A method of embodiments B1, B2, B5, B9, wherein the system information blocks broadcasted from mobile IAB comprise cell updates such as the cell suitability criteria, wherein UEs in RRC_IDLE find the current cell unsuitable and perform cell reselection.

B23. A method of embodiment 22, wherein the cell reselection measurement parameters are updates so that the UE is forced to perform cell reselection that makes it harder for the UE to fulfil conditions of the serving cell fulfilling Srxlev>S_{intraSearchP} and Squal>S_{IntraSearchQ}.

C1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform operations to transmit the user data from the host to the UE.

C2. The host of the previous embodiment, wherein:
the processing circuitry of the host is configured to execute a host application that provides the user data; and
the UE comprises processing circuitry configured to execute a client application associated with the host application to receive the transmission of user data from the host.

C3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs operations to transmit the user data from the host to the UE.

C4. The method of the previous embodiment, further comprising, at the network node, transmitting the user data provided by the host for the UE.

C5. The method of any of the previous 2 embodiments, wherein the user data is provided at the host by executing a host application that interacts with a client application executing on the UE, the client application being associated with the host application.

C6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
transmitting a first message to the UEs in RRC_IDLE and/or RRC_INACTIVE, wherein the message comprises an indication that the UEs in RRC_CONNECTED connected to the same mobile IAB are initiating (or have initiated) and handover procedure to a target cell;
receiving a message from the UE with a connection request (via the random access plus RRC setup or RRC resume procedure) in order to transit to the RRC_CONNECTED state;
transmitting a message to the CU that is hosting the target cell (in case the target cell is not hosted by the mobile IAB but by a new mobile IAB or a new network node), wherein the message comprises one or more of:
the UE context of all the UEs in RRC_INACTIVE to which have been indicated that the target cell should be their new serving cell or the cell in which there are camping, an indication whether it has been indicated to the UE to perform the RNA update or tracking area procedure,
a request to provide a random access configuration to be used by the UE when establishing a new connection towards the target cell, and
a request to provide a configuration to be sent to the UE;
receiving a message from the CU that is hosting the target cell (in case the target cell is not hosted by the mobile IAB but by a new mobile IAB or a new network node), wherein the message may include one or more of: a random access configuration to be sent to and used by the UE when establishing a new connection towards the target cell, and a configuration such as a handover command to be sent to and used by the UE; and
transmitting a second message to the UE that is RRC_CONNECTED, wherein the message comprises one or more of: a handover command to switch to a target cell, an indication about to which target cell the UEs in RRC_CONNECTED have been handed off, and a configuration to be used by the UE to perform random access in the indicated target cell.

C7. The communication system of the previous embodiment, further comprising:
the network node; and/or
the user equipment.

C8. The communication system of the previous 2 embodiments, wherein:
the processing circuitry of the host is configured to execute a host application, thereby providing the user data; and
the host application is configured to interact with a client application executing on the UE, the client application being associated with the host application.

C9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the following operations to receive the user data from the UE for the host:
transmitting a first message to the UEs in RRC_IDLE and/or RRC_INACTIVE, wherein the message comprises an indication that the UEs in RRC_CONNECTED connected to the same mobile IAB are initiating (or have initiated) and handover procedure to a target cell;
receiving a message from the UE with a connection request (via the random access plus RRC setup or RRC resume procedure) in order to transit to the RRC_CONNECTED state; transmitting a message to the CU that is hosting the target cell (in case the target cell is not hosted by the mobile IAB but by a new mobile IAB or a new network node), wherein the message comprises one or more of:
the UE context of all the UEs in RRC_INACTIVE to which have been indicated that the target cell should be their new serving cell or the cell in which there are camping, an indication whether it has been indicated to the UE to perform the RNA update or tracking area procedure,
a request to provide a random access configuration to be used by the UE when establishing a new connection towards the target cell, and
a request to provide a configuration to be sent to the UE;
receiving a message from the CU that is hosting the target cell (in case the target cell is not hosted by the mobile IAB but by a new mobile IAB or a new network node), wherein the message may include one or more of: a random access configuration to be sent to and used by the UE when establishing a new connection towards the target cell, and a configuration such as a handover command to be sent to and used by the UE; and
transmitting a second message to the UE that is RRC_CONNECTED, wherein the message comprises one or more of: a handover command to switch to a target cell, an indication about to which target cell the UEs in RRC_CONNECTED have been handed off, and a configuration to be used by the UE to perform random access in the indicated target cell.

C10. The host of the previous 2 embodiments, wherein:
the processing circuitry of the host is configured to execute a host application, thereby providing the user data; and
the host application is configured to interact with a client application executing on the UE, the client application being associated with the host application.

C11. The host of the any of the previous 2 embodiments, wherein the initiating receipt of the user data comprises requesting the user data.

C12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host.

C13. The method of the previous embodiment, further comprising at the network node, transmitting the received user data to the host.

C14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
receiving a first message from the mobile IAB, wherein the message comprises an indication that the UEs in RRC_CONNECTED connected to the same mobile IAB are initiating (or have initiated) and handover procedure to a target cell; and
initiating a first random access procedure towards the mobile IAB to transit to RRC_CONNECTED; and
receiving a second message from the mobile IAB, wherein the second message may comprise one or more of the following:
a handover command to switch to a target cell;
an indication about to which target cell the UEs in RRC_CONNECTED have been handed off; and
a configuration to be used by the UE to perform random access in the indicated target cell.

C15. The host of the previous embodiment, wherein the cellular network further includes a network node configured to communicate with the UE to transmit the user data to the UE from the host.

C16. The host of the previous 2 embodiments, wherein:
the processing circuitry of the host is configured to execute a host application, thereby providing the user data; and
the host application is configured to interact with a client application executing on the UE, the client application being associated with the host application.

C17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the following operations to receive the user data from the host:
receiving a first message from the mobile IAB, wherein the message comprises an indication that the UEs in RRC_CONNECTED connected to the same mobile IAB are initiating (or have initiated) and handover procedure to a target cell; and
initiating a first random access procedure towards the mobile IAB to transit to RRC_CONNECTED; and
receiving a second message from the mobile IAB, wherein the second message may comprise one or more of the following:
a handover command to switch to a target cell;
an indication about to which target cell the UEs in RRC_CONNECTED have been handed off; and
a configuration to be used by the UE to perform random access in the indicated target cell.

C18. The method of the previous embodiment, further comprising:
at the host, executing a host application associated with a client application executing on the UE to receive the user data from the UE.

C19. The method of the previous embodiment, further comprising:
at the host, transmitting input data to the client application executing on the UE, the input data being provided by executing the host application,
wherein the user data is provided by the client application in response to the input data from the host application.

C20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the following operations to transmit the user data to the host:
receiving a first message from a mobile IAB, wherein the message comprises an indication that the UEs in RRC_CONNECTED connected to the same mobile IAB are initiating (or have initiated) and handover procedure to a target cell; and
initiating a first random access procedure towards the mobile IAB to transit to RRC_CONNECTED; and
receiving a second message from the mobile IAB, wherein the second message may comprise one or more of the following:
a handover command to switch to a target cell;
an indication about to which target cell the UEs in RRC_CONNECTED have been handed off; and
a configuration to be used by the UE to perform random access in the indicated target cell.

C21. The host of the previous embodiment, wherein the cellular network further includes a network node configured to communicate with the UE to transmit the user data from the UE to the host.

C22. The host of the previous 2 embodiments, wherein:
the processing circuitry of the host is configured to execute a host application, thereby providing the user data; and
the host application is configured to interact with a client application executing on the UE, the client application being associated with the host application.

C23. A method implemented by a host configured to operate in a communication system that further includes a network node and a user equipment (UE), the method comprising:
at the host, receiving user data transmitted to the host via the network node by the UE, wherein the UE performs the following operations to transmit the user data to the host:
receiving a first message from the mobile IAB, wherein the message comprises an indication that the UEs in RRC_CONNECTED connected to the same mobile IAB are initiating (or have initiated) and handover procedure to a target cell; and
initiating a first random access procedure towards the mobile IAB to transit to RRC_CONNECTED; and
receiving a second message from the mobile IAB, wherein the second message may comprise one or more of the following:
a handover command to switch to a target cell;
an indication about to which target cell the UEs in RRC_CONNECTED have been handed off; and
a configuration to be used by the UE to perform random access in the indicated target cell.

C24. The method of the previous embodiment, further comprising:
at the host, executing a host application associated with a client application executing on the UE to receive the user data from the UE.

C25. The method of the previous embodiments, further comprising:
at the host, transmitting input data to the client application executing on the UE, the input data being provided by executing the host application,
wherein the user data is provided by the client application in response to the input data from the host application.

Explanations are provided below for various abbreviations/acronyms used in the present disclosure.

| Abbreviation | Explanation |
|---|---|
| BAP | Backhaul Adaptation Protocol |
| CGI | Cell Global Identifier |
| DCI | Downlink Control Indicator |
| IAB | Integrated Access and Backhaul |
| IE | Information Element |
| MAC | Medium Access Control |
| MAC CE | MAC Control Element |
| NTN | Non-Terrestrial Networks |
| VMR | Vehicle Mounted Relays |
| RRC | Radio Resource Control |
| UE | User Equipment |

1.-39. (canceled)

40. A method at a user equipment, UE that is served by a mobile integrated access and backhaul, IAB, node and which radio resource control, RRC, status is RRC_IDLE or RRC_INACTIVE, the method comprising:
receiving a first message from the mobile IAB node, wherein the first message comprises an indication that the UEs in RRC_CONNECTED connected to the mobile IAB node are initiating or have initiated a handover procedure to a target cell;
receiving a second message, from a source node IAB, when the UE RRC status is RRC_CONNECTED, wherein the second message comprises one or more of:
a cell in which the UEs in RRC_CONNECTED have been handed off; an indication for the UE to trigger a handover procedure towards a selected target cell, and a configuration that the UE needs to use to switch to the indicated target cell; and
initiating a first random access procedure towards the mobile IAB to transit to RRC_CONNECTED.

41. The method of claim 40, further comprising receiving, by the UE, from the mobile IAB via a broadcasted message comprising a system information block (SIB) or a dedicated RRC message.

42. The method of claim 40, wherein the UE does not perform the random access procedure after receiving the first indication and stays in RRC_IDLE or RRC_INACTIVE and performs a cell selection or a cell reselection procedure towards the indicated target cell.

43. The method of claim 40, wherein the first indication is received in a first message, wherein the first message comprises one or more of:
a cell in which the UEs in RRC_CONNECTED have been handed off; and a configuration that the UE needs to use to switch to the indicated target cell.

44. The method of claim 40, wherein responsive to switching to a target cell, not performing a cell selection or a cell reselection procedure and directly performing a simplified Random Access procedure towards that indicated target cell, and wherein an indication for the UE to transit to RRC_CONNECTED comprises a simple one-bit indication and/or additional information comprising the configuration so to make easier the random access procedure of the UE towards the mobile IAB.

45. The method of claim 40, wherein the indication comprises a configuration for the UE to be used in the target cell once the handover has been completed.

46. The method of claim 45, wherein switching to a target cell comprises performing the Random Access procedure towards that indicated target cell; and
wherein the configuration further comprises an indication on whether to perform a radio access network notification area, RNA, update or tracking area update procedure towards the indicated target cell.

47. The method of claim 45, further comprising receiving, by the UE, a configuration for initiating a random access procedure towards an indicated target cell comprising the RRC_IDLE or RRC_INACTIVE and then performing the random access procedure towards the indicated target cell; and
not performing a cell selection procedure or a cell reselection procedure as the cell to which the UE will establish a new connection that is already indicated by the mobile IAB.

48. The method of claim 40, wherein responsive to receiving, by the UE, an indication that the other UEs in RRC_CONNECTED have been handed off to a target cell, considering the target cell as a new cell in which the is camping and not triggering any radio access network notification area, RNA, update or tracking area procedure.

49. The method of claim 40, further comprising receiving a trigger to perform at least one of a radio access network notification area update, RNAU, procedure, a tracking area update, TAU, procedure, and a cell (re) selection procedure.

50. A method at a mobile integrated access and backhaul, IAB, node that has or will initiate an handover procedure for its user equipments, UEs, in RRC_CONNECTED, the method comprising:
transmitting a first message to the UEs in RRC_IDLE and/or RRC_INACTIVE, wherein the first message comprises an indication that the UEs in RRC_CONNECTED connected to the same mobile IAB are initiating or have initiated a handover procedure to a target cell;
receiving a message from a UE with a connection request via a random access plus radio resource control, RRC, setup or RRC resume procedure in order to transit to the RRC_CONNECTED state;
transmitting a message to the centralized unit, CU, that is hosting the target cell, wherein the message comprises one or more of:
the UE context of all the UEs in RRC_INACTIVE to which have been indicated that the target cell should be their new serving cell or the cell in which they are camping, an indication whether it has been indicated to the UE to perform a radio access network notification area, RNA, update or tracking area procedure,
a request to provide a random access configuration to be used by the UE when establishing a new connection towards the target cell, and
a request to provide a configuration to be sent to the UE;
receiving a message from the CU that is hosting the target cell, wherein the message may include one or more of: a random access configuration to be sent to and used by the UE when establishing a new connection towards the target cell, and a configuration such as a handover command to be sent to and used by the UE; and
transmitting a second message to the UE that is RRC_CONNECTED, wherein the message comprises one or more of: a handover command to switch to a target cell, an indication about to which target cell the UEs in RRC_CONNECTED have been handed off, and a configuration to be used by the UE to perform random access in the indicated target cell.

51. The method of claim 50, wherein the configuration comprises a random access configuration plus a set of configurations to be used once the random access has been performed.

52. The method of claim 50, wherein the first message sent to the UE is done via one of:
a broadcasted message comprising a system information block (SIB); or
a group signaling comprising a paging message.

53. The method of claim 50, wherein the second message sent to the UE is done via one of:
a new or existing dedicate RRC message via a MAC CE, via L1 signaling; or
a broadcasted message comprising a system information block (SIB).

54. The method of claim 50, wherein the first message comprises one or more of:
a cell or a list of cells in which the other UEs in RRC_CONNECTED have been handed off, and
a configuration that the UE needs to use to switch to the indicated target cell.

55. The method of claim 54, wherein the first message comprises:
an indication for the UE to transit to RRC_CONNECTED; and
an indication on whether to perform the RNA update or tracking area update procedure towards the indicated target cell.

56. The method of claim 55, wherein the indication comprises a simple one-bit indication and/or additional information comprising a configuration to make the random access procedure of the UE towards the mobile IAB easier.

57. The method of claim 50, wherein the paging message is sent directly by the mobile IAB by RAN-paging or a request to the AMF in which the mobile IAB is connected is sent in order to trigger a paging message from the AMF for core network paging to the UE.

58. The method of claim 50, further comprising receiving, by the mobile IAB, the second message that comprises:
a cell or a list of cells in which the UEs in RRC_CONNECTED have been handed off; a configuration for the UEs in RRC_IDLE and/or RRC_INACTIVE that indicate those UE to switch to a target cell.

59. A user equipment, UE comprising:
processing circuitry; and
memory coupled with the processing circuitry, wherein the memory includes instructions that when executed by the processing circuitry causes the UE to perform operations according to claim 40.

60. An integrated access and backhaul, IAB, node comprising:
processing circuitry; and
memory coupled with the processing circuitry, wherein the memory includes instructions that when executed by the processing circuitry causes the IAB node to perform operations according to claim 50.
